(19) United States
(12) Patent Application Publication
(10) Pub. No.: US 2014/0136615 A1
(43) Pub. Date: May 15, 2014

(54) ADDRESS BOOK FOR BUSINESSES

(71) Applicant: CELLCO PARTNERSHIP D/B/A VERIZON WIRELESS, Basking Ridge, NJ (US)

(72) Inventor: Shunge Li, Peachtree Corners, GA (US)

(73) Assignee: CELLCO PARTNERSHIP D/B/A VERIZON WIRELESS, Basking Ridge, NJ (US)

(21) Appl. No.: 13/675,468

(22) Filed: Nov. 13, 2012

(51) Int. Cl. H04L 29/08

(52) U.S. Cl. CPC H04L 67/22
USPC 709/204

(57) ABSTRACT

A computer device may include logic configured to receive an indication from a user device that a user, associated with the user device, has added a business to an address book associated with the user device and include the business in the address book associated with the user device. The logic may further be configured to receive an update from a business device associated with the business; identify that the business is included in the address book associated with the user device; and send the update to the user device in response to receiving the update and based on identifying that the business is included in the address book associated with the user device.

### BACKGROUND INFORMATION

A user of a mobile communication device may interact with a large number of businesses. The user may interact with a business by, for example, using a mobile browser application to access a web site associated with the business. For example, if the user wants to know if the business is open, the user may visit the web site to determine the business hours of the business or may call the business to determine whether the business is open. As another example, if the user wants directions to a place of business, the user may activate a mapping application and may type in the name of the business to obtain the directions. As yet another example, the user may obtain private information, such as an account balance, by logging into an account, associated with the user, on the web site associated with the business. Interacting with, or obtaining information about, a business using different applications may be slow and inconvenient.

### BRIEF DESCRIPTION OF THE DRAWINGS

FIG. 1 is a diagram illustrating an exemplary environment according to an implementation described herein;

FIG. 2 is a diagram illustrating an exemplary device that may be included in a component of the environment of FIG. 1 according to an implementation described herein;

FIG. 3 is a diagram illustrating an exemplary user device that may be included in a component of the environment of FIG. 1 according to an implementation described herein;

FIG. 4A is a diagram illustrating exemplary functional components of the address book system of FIG. 1 according to an implementation described herein;

FIG. 4B is a diagram illustrating exemplary functional components of the user device of FIG. 1 according to an implementation described herein;

FIG. 5 is a diagram illustrating exemplary components of the address book memory of FIG. 4B according to an implementation described herein;

FIG. 6 is a flowchart of an exemplary process for providing updates for a business to users' address books according to an implementation described herein;

FIG. 7 is a flowchart of an exemplary process for adding a business to a user's address book according to an implementation described herein;

FIG. 8 is a flowchart of an exemplary process for obtaining information relating to a business for an address book according to an implementation described herein;

FIG. 9 is a flowchart of an exemplary process for determining a nearest business location according to an implementation described herein;

FIG. 10 is a diagram of a first exemplary user interface according to an implementation described herein;

FIGS. 11A-11B are diagrams of a second exemplary user interface according to an implementation described herein; and

FIG. 12 is a diagram of a third exemplary user interface according to an implementation described herein.

### DETAILED DESCRIPTION OF PREFERRED EMBODIMENTS

The following detailed description refers to the accompanying drawings. The same reference numbers in different drawings identify the same or similar elements.

An implementation described herein relates to an address book for businesses implemented by a user device, such as a mobile communication device. The address book for businesses may be implemented as part of an address book application used by a user to manage contacts or may be implemented as a separate application from an existing address book application. The address book for businesses (referred to hereinafter as “address book”) may communicate with an address book system. The address book system may enable businesses to register with the address book system and provide information relating to the businesses to the address book system. A user may select to add a particular business to the address book and the address book system may provide the information relating to the particular business to a user device associated with the user.

The information may include a location associated with the particular business, presence information associated with the particular business, contact information associated with the particular business, promotion information associated with the particular business, hyperlinks associated with the particular business, stock information associated with the particular business, user reviews associated with the particular business, businesses related to the particular business, private information relating to the user's account with the particular business, and/or other types of information associated with the particular business. A user may access the information by selecting an address book entry associated with the particular business in the address book of the user device associated with the user.

The address book system may provide updates about the particular business to the user device. For example, the address book system may receive an update from the particular business, such as a new promotion, a change in presence information, a change in stock information, a change in contact information, and/or another type of update. The address book system may identify users that have included the particular business in their address book and may send the update to user devices associated with the identified users. A user may configure an address book entry to provide notifications of an update and may receive a notification when an update has been received for the address book entry. Additionally, an update relating to private information associated with the user, such as information relating to the user's account with a business, may be received by the user device from a device associated with the particular business.

A user may select an address book entry and the user device may request information relating to a business, associated with the selected address book entry, from the address book system. For example, the user device may request a nearest location associated with the business based on the user's location or based on a particular location selected by the user. The address book system may determine the nearest location associated with the business based on one or more filters selected by the user. As another example, the user device may request presence information associated with the business. Presence information may include any information related to the availability of services associated with the business, such as, for example, whether the business is open, how busy the business is, an estimated wait time to talk to a customer representative, and/or other types of availability information.

A business, as the term is used herein, may refer to any entity, organization, or device that provides products and/or services to customers. For example, a business may include a business associated with a single location, a regional or national chain with multiple locations, a franchise, an online business without a brick-and-mortar presence, a non-profit organization, a business category (e.g., gas station, Automated Teller Machine (ATM), etc.), a collection of businesses at a particular location (e.g., a shopping mall), and/or another type of entity, organization, or device.

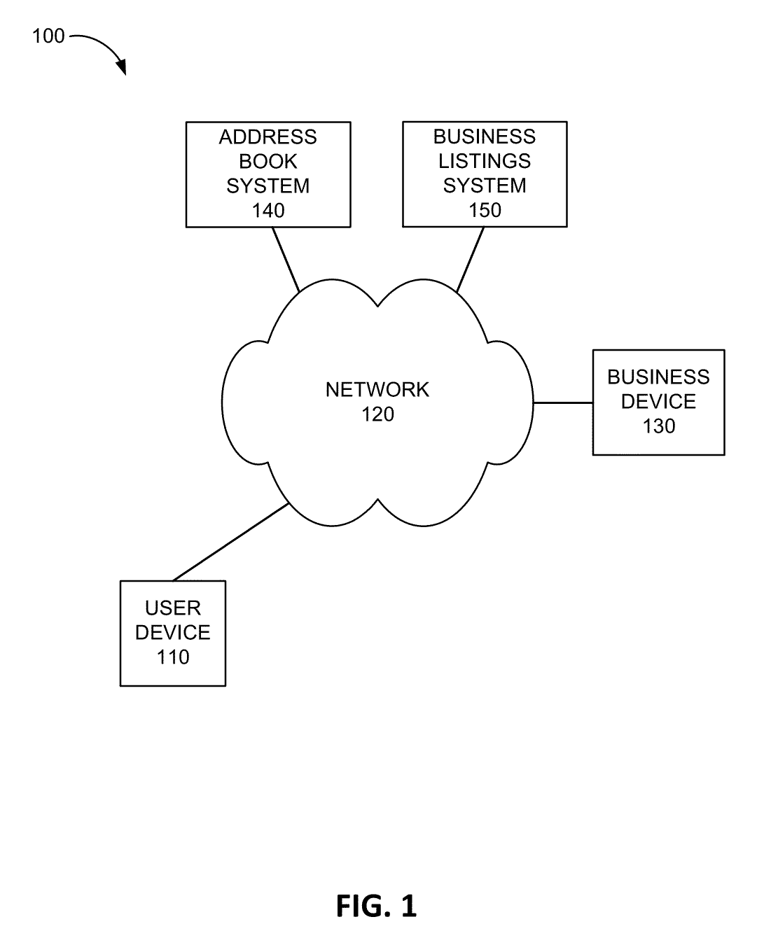

FIG. 1 is a diagram illustrating an exemplary environment 100 according to an implementation described herein. As shown in FIG. 1, environment 100 may include a user device 110, a network 120, a business device 130, an address book system 140, and a business listings system 150.

User device 110 may include any device capable of communicating with address book system 140 and business device 130, and which includes an address book application. For example, user device 110 may include a mobile phone, a smart phone, a tablet computer, a laptop computer, a personal digital assistant (PDA), a gaming system, a media playing device, a health monitoring device, or another type of portable communication device. As another example, user device 110 may include a desktop computer, a set-top box, a telephone device with video capability, and/or another type of communication device. User device 110 may include an address book that stores information relating to businesses and that receives updates for businesses stored in the address book.

Network 120 may enable user device 110, business device 130, address book system 140, and/or business listings system 150 to communicate with each other. Network 120 may include one or more wired and/or wireless networks. For example, network 120 may include a cellular network, the Public Land Mobile Network (PLMN), a second generation (2 G) network, a third generation (3 G) network, a fourth generation (4 G) network (e.g., a long term evolution (LTE) network), a fifth generation (5 G) network, a code division multiple access (CDMA) network, a global system for mobile communications (GSM) network, a general packet radio services (GPRS) network, a combination of the above networks, and/or another type of wireless network. Additionally, or alternatively, network 120 may include a local area network (LAN), a wide area network (WAN), a metropolitan area network (MAN), an ad hoc network, a WiFi network, a wireless LAN network, an intranet, the Internet, a fiber optic-based network (e.g., a fiber optic service network), a satellite network, a television network, and/or a combination of these or other types of networks.

Business device 130 may include one or more devices, such as server devices, that are associated with a particular business and that provide information relating to the particular business to address book system 140. For example, business device 130 may include a server device that hosts a web site associated with the particular business, may include a point-of-sale device associated with the particular business, may include an administration server associated with the particular business, and/or may include another type of device associated with the business. Furthermore, business device 130 may provide private and/or personalized information, relating to a particular user, to user device 110 associated with the particular user without sending the private and/or personalized information through address book system 140.

Address book system 140 may include one or more devices, such as server devices, that maintain and provide information relating to particular businesses to an address book associated with user device 110. Address book system 140 may obtain information relating to a business and may store the obtained information. Address book system 140 provide the information relating to the business to user device 110 in response to the user of user device 110 adding the business to the address book and/or in response to the user selecting an address book entry associated with the business. Furthermore, address book system 140 may receive update information relating to the business and may provide the update information to user device 110.

Business listings system 150 may include one or more devices, such as server devices, that may include a listing of businesses, such as, for example, a yellow pages server device. Address book system 140 may access business listings system 150 when a business has not registered with address book system 140. For example, a user may request to add a business to the address book of user device 110 and the business may not be registered with address book system 140. In response, address book system 140 may obtain information relating to the business from business listings system 150.

Although FIG. 1 show exemplary components of environment 100, in other implementations, environment 100 may include fewer components, different components, differently arranged components, or additional components than depicted in FIG. 1. Additionally or alternatively, one or more components of environment 100 may perform functions described as being performed by one or more other components of environment 100.

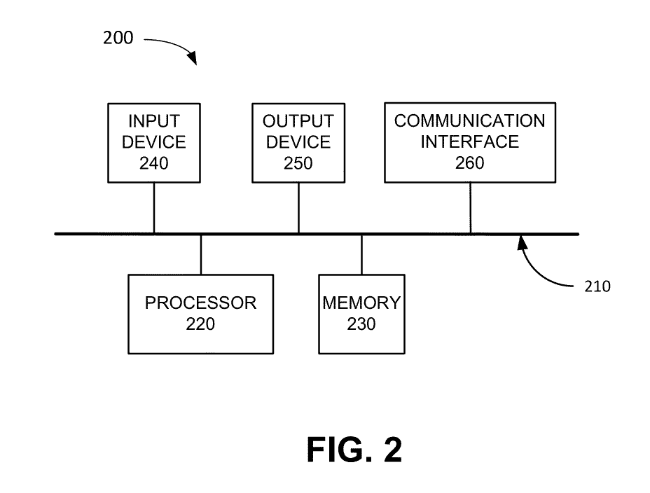

FIG. 2 is a diagram illustrating an exemplary device 200 that may be included in a component of the environment of FIG. 1 according to an implementation described herein. User device 110, business device 130, address book system 140, and/or business listings system 150 may each include one or more devices 200. As shown in FIG. 2, device 200 may include a bus 210, a processor 220, a memory 230, an input device 240, an output device 250, and a communication interface 260.

Bus 210 may include a path that permits communication among the components of device 200. Processor 220 may include any type of single-core processor, multi-core processor, microprocessor, latch-based processor, and/or processing logic (or families of processors, microprocessors, and/or processing logics) that interprets and executes instructions. In other embodiments, processor 220 may include an application-specific integrated circuit (ASIC), a field-programmable gate array (FPGA), and/or another type of integrated circuit or processing logic.

Memory 230 may include any type of dynamic storage device that may store information and/or instructions, for execution by processor 220, and/or any type of non-volatile storage device that may store information for use by processor 220. For example, memory 230 may include a random access memory (RAM) or another type of dynamic storage device, a read-only memory (ROM) device or another type of static storage device, a content addressable memory (CAM), a magnetic and/or optical recording memory device and its corresponding drive (e.g., a hard disk drive, optical drive, etc.), and/or a removable form of memory, such as a flash memory.

Input device 240 may allow an operator to input information into device 200. Input device 240 may include, for example, a keyboard, a mouse, a pen, a microphone, a remote control, an audio capture device, an image and/or video capture device, a touch-screen display, a scanner, a camera, a barcode reader, a radio frequency identification (RFID) reader, a sensor, and/or another type of input device. In some embodiments, device 200 may be managed remotely and may not include input device 240. In other words, device 200 may be “headless” and may not include a keyboard, for example.

Output device 250 may output information to an operator of device 200. Output device 250 may include a display, a printer, a speaker, and/or another type of output device. For example, device 200 may include a display, which may include a liquid-crystal display (LCD) for displaying content to the customer. In some embodiments, device 200 may be managed remotely and may not include output device 250. In other words, device 200 may be “headless” and may not include a display, for example.

Communication interface 260 may include a transceiver that enables device 200 to communicate with other devices and/or systems via wireless communications (e.g., radio frequency, infrared, and/or visual optics, etc.), wired communications (e.g., conductive wire, twisted pair cable, coaxial cable, transmission line, fiber optic cable, and/or waveguide, etc.), or a combination of wireless and wired communications. Communication interface 260 may include a transmitter that converts baseband signals to radio frequency (RF) signals and/or a receiver that converts RF signals to baseband signals. Communication interface 260 may be coupled to an antenna for transmitting and receiving RF signals.

Communication interface 260 may include a logical component that includes input and/or output ports, input and/or output systems, and/or other input and output components that facilitate the transmission of data to other devices. For example, communication interface 260 may include a network interface card (e.g., Ethernet card) for wired communications and/or a wireless network interface (e.g., a WiFi) card for wireless communications. Communication interface 260 may also include a universal serial bus (USB) port for communications over a cable, a Bluetooth™ wireless interface, a radio-frequency identification (RFD)) interface, a near-field communications (NFC) wireless interface, and/or any other type of interface that converts data from one form to another form.

As will be described in detail below, device 200 may perform certain operations relating to managing an address book that includes business entries. Device 200 may perform these operations in response to processor 220 executing software instructions contained in a computer-readable medium, such as memory 230. A computer-readable medium may be defined as a non-transitory memory device. A memory device may be implemented within a single physical memory device or spread across multiple physical memory devices. The software instructions may be read into memory 230 from another computer-readable medium or from another device. The software instructions contained in memory 230 may cause processor 220 to perform processes described herein. Alternatively, hardwired circuitry may be used in place of, or in combination with, software instructions to implement processes described herein. Thus, implementations described herein are not limited to any specific combination of hardware circuitry and software.

Although FIG. 2 shows exemplary components of device 200, in other implementations, device 200 may include fewer components, different components, additional components, or differently arranged components than depicted in FIG. 2. Additionally or alternatively, one or more components of device 200 may perform one or more tasks described as being performed by one or more other components of device 200.

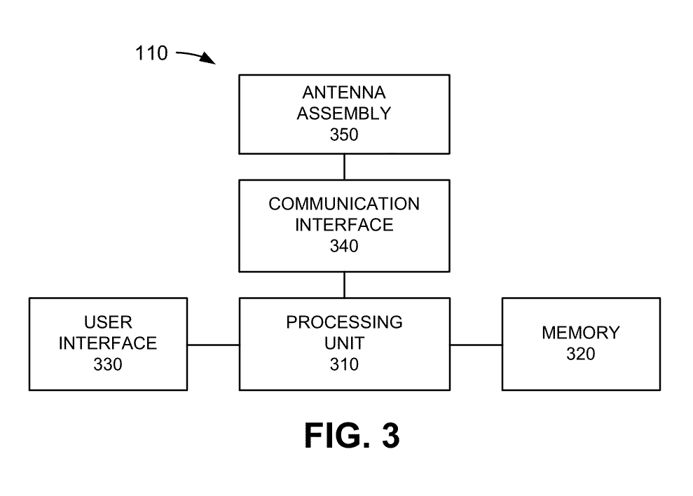

FIG. 3 is a diagram illustrating example components of a mobile communication device that may correspond to user device 110 according to an implementation described herein. As shown in FIG. 3, user device 110 may include a processing unit 310, a memory 320, a user interface 330, a communication interface 340, and an antenna assembly 350.

Processing unit 310 may include one or more processors, microprocessors, application specific integrated circuits (ASICs), field programmable gate arrays (FPGAs), or other processing logic. Processing unit 310 may control operation of user device 110 and its components.

Memory 320 may include a random access memory (RAM) or another type of dynamic storage device, a read only memory (ROM) or another type of static storage device, a removable memory card, and/or another type of memory to store data and instructions that may be used by processing unit 310.

User interface 330 may include mechanisms for inputting information to user device 110 and/or for outputting information from user device 110. Examples of input and output mechanisms might include a speaker to receive electrical signals and output audio signals; a camera lens to receive image and/or video signals and output electrical signals; a microphone to receive audio signals and output electrical signals; buttons (e.g., a joystick, control buttons, a keyboard, or keys of a keypad) and/or a touchscreen to permit data and control commands to be input into user device 110; a display, such as an LCD, to output visual information; a vibrator to cause user device 110 to vibrate; and/or any other type of input or output device.

Communication interface 340 may include a transceiver that enables user device 110 to communicate with other devices and/or systems via wireless communications (e.g., radio frequency, infrared, and/or visual optics, etc.), wired communications (e.g., conductive wire, twisted pair cable, coaxial cable, transmission line, fiber optic cable, and/or waveguide, etc.), or a combination of wireless and wired communications. Communication interface 340 may include a transmitter that converts baseband signals to radio frequency (RF) signals and/or a receiver that converts RF signals to baseband signals. Communication interface 340 may be coupled to antenna assembly 350 for transmitting and receiving RF signals.

Communication interface 340 may include a logical component that includes input and/or output ports, input and/or output systems, and/or other input and output components that facilitate the transmission of data to other devices. For example, communication interface 340 may include a network interface card (e.g., Ethernet card) for wired communications and/or a wireless network interface (e.g., a WiFi) card for wireless communications. Communication interface 340 may also include a USB port for communications over a cable, a Bluetooth™ wireless interface, an RFID interface, an NFC wireless interface, and/or any other type of interface that converts data from one form to another form.

Antenna assembly 350 may include one or more antennas to transmit and/or receive RF signals over the air. Antenna assembly 350 may, for example, receive RF signals from communication interface 340 and transmit the signals over the air and receive RF signals over the air and provide them to communication interface 340.

As described herein, user device 110 may perform certain operations in response to processing unit 310 executing software instructions contained in a computer-readable medium, such as memory 320. A computer-readable medium may be defined as a non-transitory memory device. A memory device may include memory space within a single physical memory device or spread across multiple physical memory devices. The software instructions may be read into memory 320 from another computer-readable medium or from another device via communication interface 340. The software instructions contained in memory 320 may cause processing unit 310 to perform processes that will be described later. Alternatively, hardwired circuitry may be used in place of, or in combination with, software instructions to implement processes described herein. Thus, implementations described herein are not limited to any specific combination of hardware circuitry and software.

Although FIG. 3 shows example components of user device 110, in other implementations, user device 110 may include fewer components, different components, differently arranged components, or additional components than depicted in FIG. 3. Additionally or alternatively, one or more components of user device 110 may perform the tasks described as being performed by one or more other components of user device 110.

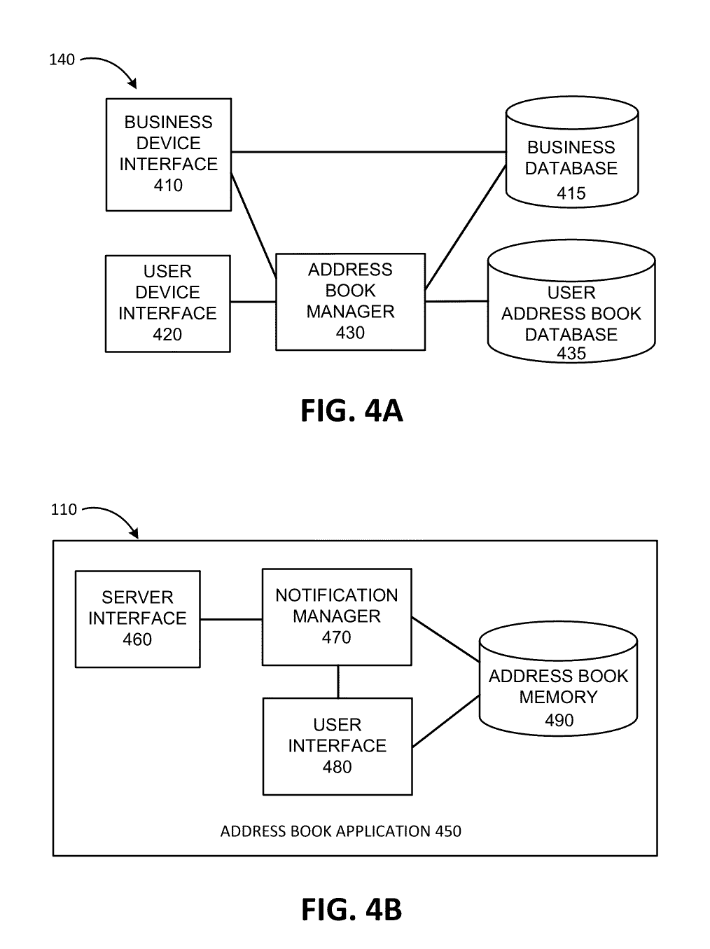

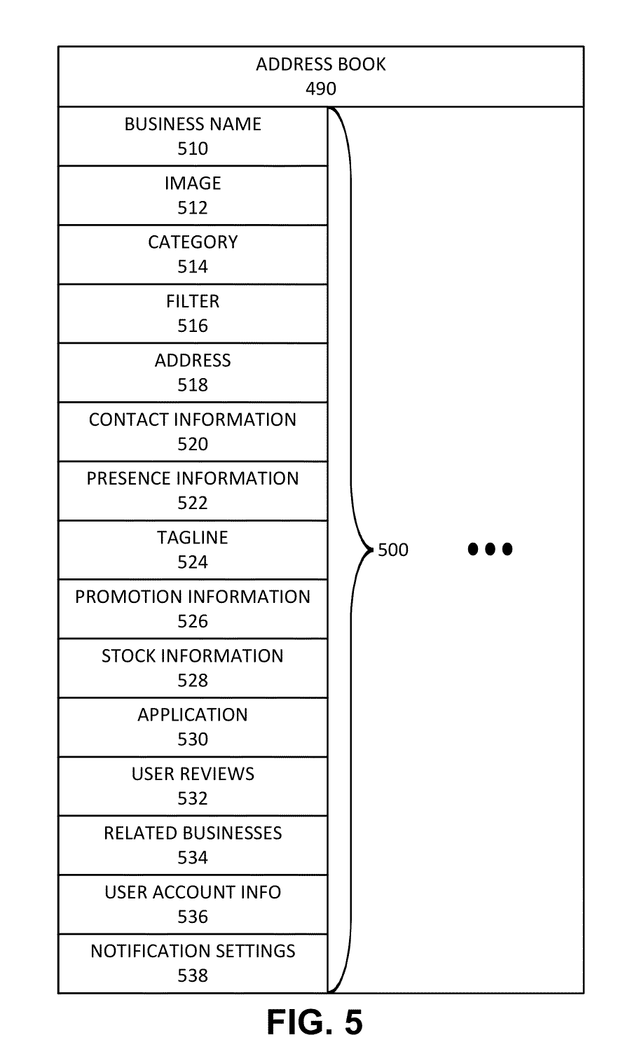

FIG. 4A is a diagram illustrating exemplary functional components of address book system 140 according to an implementation described herein. The functional components of address book system 140 may be implemented, for example, via processor 220 executing instructions from memory 230. Alternatively, some or all of the functional components of address book system 140 may be implemented via hard-wired circuitry. As shown in FIG. 4A, address book system 140 may include a business device interface 410, a business database 415, a user device interface 420, an address book manager 430, and a user address book database 435.

Business device interface 410 may enable address book system 140 to communicate with business device 130. For example, business device interface 410 may provide a portal for business device 130 to register with address book system 140 and to provide information to address book system 140. For example, business device interface 410 may provide a web page that may enable an administrator associated with a business to enter information via business device 130. As another example, business device interface 410 may establish a communication session with business device 130 to receive update information from business device 130, such as presence information, stock or availability information relating to products offered by the business, etc.

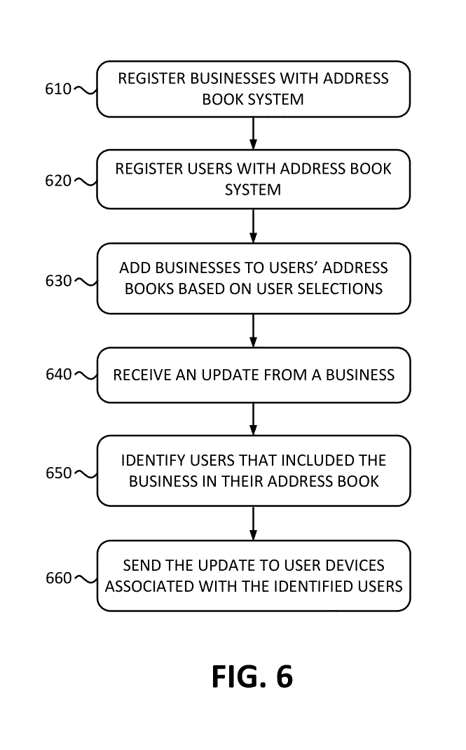

Business database 415 may store information associated with particular businesses. For example, for each business registered with address book system 140, business database 415 may store information that may be provided to user device 110. Information that may be stored in business database 415 may correspond to information stored in address book memory 490 of user device 110, which is described below with reference to FIG. 5.

User device interface 420 may enable address book system 140 to communicate with user device 110. For example, user device interface 420 may enable a user to register with address book system 140 and/or may receive an indication that a user has added a business to the user's address book. Furthermore, user device interface 420 may send updates, associated with businesses that a user has added to the user's address book, to a user device 110 associated with the user. Moreover, user device interface 420 may receive a request from user device 110, associated with a user, for information associated with a business in the user's address book. As mentioned above, private information may be provided to user device 110 by business device 130 without sending the private information to address book system 140. Address book manager 430 may manage address book information for users. For example, address book manager 430 may receive an indication from user device 110, associated with a user, that the user has added a business to the user's address book. In response, address book manager 430 may associate the added business with the user in user address book database 435. When an update is received from a business, address book manager 430 may identify users that have added the business to their address book and may send the update to user devices 110 associated with the identified users. When a user selects a business in the user's address book, user device 110 may request information associated with the business from address book system 140 and address book manager 430 may retrieve the information from business database 415 and send the information to user device 110. For example, address book manager 430 may determine a nearest location associated with the business and may send the address of the nearest location to user device 110.

User address book database 435 may store information about address books associated with particular users. For example, user address book database 435 may store, for each user, information identifying a user device 110 associated with the user and business that the user has added to the user's address book.

Although FIG. 4A shows exemplary functional components of address book system 140, in other implementations, address book system 140 may include fewer functional components, different functional components, differently arranged functional components, or additional functional components than depicted in FIG. 4A. Additionally or alternatively, one or more functional components of address book system 140 may perform functions described as being performed by one or more other functional components of address book system 140.

FIG. 4B is a diagram illustrating exemplary functional components of user device 110 according to an implementation described herein. The functional components of user device 110 may be implemented, for example, via processing unit 310 executing instructions from memory 320. Alternatively, some or all of the functional components of user device 110 may be implemented via hard-wired circuitry. As shown in FIG. 4B, user device 110 may include an address book application 450. Address book application 450 may store information relating to contacts associated with a user. In some implementations, address book application 450 may store information relating to personal contacts associated with the user as well as businesses that the user has selected to include in the address book. In other implementations, address book application 450 may be dedicated to store information relating to business and may be separate from an address book application that stores information relating to personal contacts associated with the user. In some implementations, address book application 450 may be installed on user device 110 without user action. For example, address book application 450 may be included on user device 110 when user device 110 is purchased. In other implementations, address book application 450 may need to be downloaded by the user. For example, the user may download address book application 450 from address book system 140.

Address book application 450 may include a server interface 460, a notification manager 470, a user interface 480, and an address book memory 490. Server interface 460 may enable user device 110 to communicate with address book system 140 and/or with business device 130. For example, server interface 460 may send an indication to address book system 140 that a user has selected to add a business to the user's address book and may obtain information relating to the business from address book system 140. As another example, server interface 460 may obtain an update relating to a business from address book system 140 and may update an address book entry associated with the business based on the received update. As yet another example, server interface 460 may receive private and/or personalized information, associated with the user's account with the business, from business device 130 and/or may request the private and/or personalized information from business device 130.

Notification manager 470 may generate a notification in response to an update received for a business in the user's address book. Notification manager 470 may determine whether to generate a notification based on settings selected by the user, based on an importance rating associated with a received update, based on the business associated with the received update, and/or based on another criterion. For example, notification manager 470 may generate a visual and/or an audible notification, such as a popup message, an icon, an audio tone, and/or another type of notification.

User interface 480 may generate or provide a user interface associated with address book application 450. As an example, user interface 480 may generate a selection object, such as a clickable icon, that a user may select to add a business to the address book (e.g., while a user is accessing a web site associated with a business). As another example, if the user activates address book application 450, user interface 480 may display a list of businesses that the user has added to the address book. If the user selects one of the businesses, user interface 480 may display information relating to the selected business.

Address book memory 490 may store address book entries for business that have been added to the address book by the user. Exemplary information that may be stored in address book memory 490 is described below with reference to FIG. 5.

Although FIG. 4B shows exemplary functional components of user device 110, in other implementations, user device 110 may include fewer functional components, different functional components, differently arranged functional components, or additional functional components than depicted in FIG. 4B. Additionally or alternatively, one or more functional components of user device 110 may perform functions described as being performed by one or more other functional components of user device 110.

FIG. 5 is a diagram illustrating exemplary components of address book memory 490 according to an implementation described herein. As shown in FIG. 5, address book memory 490 may include one or more business records 500 (referred to herein collectively as “business records 500” and individually as “business record 500”). Each business record 500 may store information for a particular business that was added by the user to the address book. A business record 500 may also be created for a particular product and/or service offered by a particular business. A hierarchical structure may be used to indicate a one-to-many relationship between a business record 500 associated with a particular business and business records 500 associated with products and/or services offered by the particular business. Business record 500 may include a business name field 510, an image field 512, a category field 514, a filter field 516, an address field 518, a contact information field 520, a presence information field 522, a tagline field 524, a promotion information field 526, a stock information field 528, an application field 530, a user reviews field 532, a related businesses field 534, user account information field 536, and notification settings field 538.

Business name field 510 may store a name of the particular business. Image field 512 may store an image associated with the particular business (e.g., a logo). Category field 514 may store information relating to a category associated with the particular business. As an example, category field 514 may store a business listing category and subcategory associated with the business. Thus, if the business corresponds to an Italian restaurant, category field 514 may store a “restaurant” category classification and an “Italian” subcategory classification. As another example, business record 500 may correspond to a business category, rather than a particular business, such as, for example, “gas station,” “automated teller machine,” “emergency medical center,” “convenience store.” etc. In such cases, business name field 510 may be empty and address book manager 430 of address book system 140 may, in response to the user selecting the address book entry associated with business record 500, identify a nearest location for a business that matches the category identified in category field 514.

Filter field 516 may store one or more filters associated with the particular business. A user may select a filter for determining a location associated with a business, or with a business category. As an example, if the business category corresponds to an emergency medical center, the filter may correspond to a medical insurance associated with the user. As another example, if the business category corresponds to a gas station, the filter may correspond to a particular brand of gas station.

Address field 518 may store an address associated with the particular business. The address may correspond to a nearest location associated with the particular business. For example, if the user selects the address book entry corresponding to business record 500, address book application 450 may request information associated with the business from address book system 140. The request may include information about the location of user device 110 and the obtained information may include the nearest location of the business to user device 110.

Contact information field 520 may store contact information associated with the particular business. The contact information may include a phone number associated with the particular business, a web site address associated with the particular business, an email address associated with the particular business, an instant messaging address associated with the particular business, a social media account associated with the particular business, and/or other types of contact information associated with the business.

Presence information field 522 may include presence information associated with the particular business. The presence information may include, for example, business hours associated with the particular business, whether the particular business is open, how busy a location associated with the business is, a wait time to speak to a customer representative on the phone, a wait time to chat with a customer representative using instant messaging, and/or other types of presence information associated with the particular business.

Tagline field 524 may include a tagline associated with the particular business. A tagline may include a slogan associated with the business and/or another type of short message that the business uses to identify and distinguish itself. Promotion information field 526 may include promotion information associated with the particular business. For example, promotion information field 526 may include an offer provided by the particular business, information relating to a sale being conducted by the particular business, a guarantee or warranty being offered by the business, and/or another type of promotion being offered by the business.

Stock information field 528 may include information relating to the availability of a product or a service being offered by the business. For example, stock information field 528 may include information relating to whether a particular product is in stock at a particular location, whether a particular service is available at a particular location, and/or may include other types of stock information associated with the particular business.

Application field 530 may store information relating to one or more applications associated with the particular business. For example, the particular business may provide an application that may be installed on user device 110 and application field 530 may be used to generate a selection object that may be used to activate the application when a user is accessing the address book entry associated with the particular business. If the particular business includes an application store, application field 530 may include a link to the application store.

User reviews field 532 may store information relating to reviews of the particular business generated by other users. For example, users may rate the particular business on a rating scale and/or may rate a particular product or service offered by the particular business. The ratings may be averaged, and the averaged rating may be displayed when the user access the address book entry associated with the particular business. Furthermore, the user may be provided with an option to read individual reviews written by other users.

Related businesses field 534 may store information about businesses related to the particular business. A related business may be identified by address book system 140 based on explicit information provided by an administrator of address book system 140 or by a user. Additionally or alternatively, a related business may be inferred from actions performed by users. For example, if a user accesses an address book entry for a first business and then accesses an address book entry for a second business, the first and second businesses may be identified as being related. Additionally or alternatively, related businesses field 534 may store information relating to nearby businesses associated with the particular business (e.g., business located in the same shopping mall).

User account information field 536 may store information relating to the user's account with the particular business. For example, user account information may store a username and/or password associated with the user that may be used to automatically log the user into a web site associated with the user (e.g., business device 130). Furthermore, user account information field 536 may include information relating to orders placed by the user with the business. For example, address book application 450 may receive an update relating to an order placed by the user, such as a tracking number associated with an order that has been shipped. Furthermore, for some business, public information, which may not require authentication but which may be of interest to the user, may be received from business device 130 and stored in user account information field 536. Examples of such information may include flight status information for an airline or score information for a game being played by a sport team.

Notification settings field 538 may store notification settings associated with the particular business. A user may set one or more notifications associated with the business. For example, the user may indicate whether a notification should be generated by address book application 450 when an update has been received from the business. In some implementations, the user may assign an importance rating to the business and a notification may be generated based on the assigned importance rating. For example, if an update is received for a business with a high importance rating, a notification may be generated and if an update is received for a business with a low importance rating, a notification may not be generated. In other implementations, the user may select what kind of updates should generate a notification. For example, a user may select to generate a notification when an update to an order placed by the user is received. As another example, a user may select to generate a notification when an update about a new promotion is received. As yet another example, a user may select to generate a notification when a business becomes less busy. As yet another example, a user may select to never generate notifications for a particular business.

Although FIG. 5 shows exemplary components of address book memory 490, in other implementations, address book memory 490 may include fewer fields, different fields, differently arranged fields, or additional fields than depicted in FIG. 5.

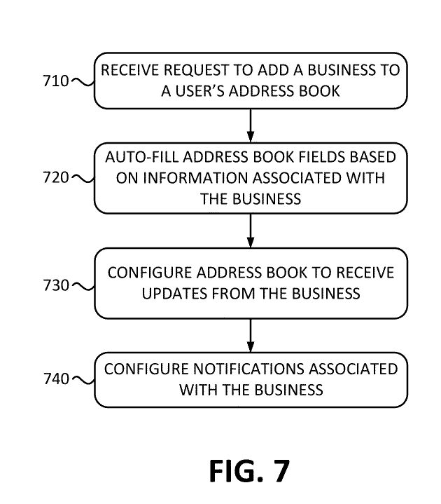

FIG. 6 is a flowchart of an exemplary process for providing updates for a business to users' address books according to an implementation described herein. In one implementation, the process of FIG. 6 may be performed by address book system 140. In other implementations, some or all of the process of FIG. 6 may be performed by another device or a group of devices separate from address book system 140 and/or including address book system 140.

The process of FIG. 6 may include registering businesses with an address book system (block 610). For example, a business may register by accessing address book system 140 via business device 130 and may provide information relating to the business to address book system 140. Furthermore, business device 130 may be configured to provide updates to address book system 140. The updates may include changes to any information that may be stored in business database 415 and provided to user device 110 to be stored in address book memory 490, such as changes to an address, changes to contact information, changes in promotion information, changes in presence information, changes in stock information, etc.

Users may register with the address book system (block 620). In some implementations, users may be automatically registered if address book application 450 is installed on user device 110. Thus, if address book application 450 is provided on user device 110 when user device 110 is first purchased, powered up, or initially connected to network 120, users may already be registered with address book system 140. In other implementations, a user may need to explicitly register with address book system 140. For example, a user may access a web site associated with address book system 140 and register, and may be provided with address book application 450 after registering.

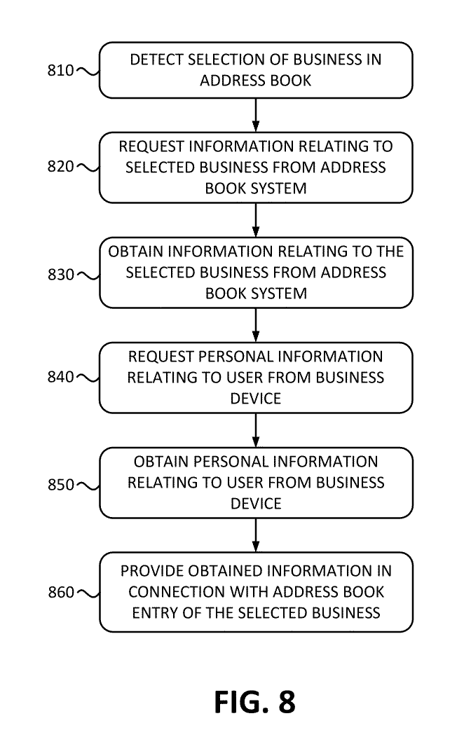

Businesses may be added to users' address books based on users' selections (block 630). For example, a user may add a business to address book memory 490, via browsing a business directory or address book system 140, and address book application 450 may send an indication to address book system 140 that the business has been added to the user's address book. In response, address book system 140 may associate the user with the added business in user address book database 435. A process of adding a business to the address book is described in more detail below with reference to FIG. 7.

An update may be received from a business (block 640). For example, business device 130 may send an update relating to the business to address book system 140 or an update relating to personalized/private information to user device 110. The update may include a new promotion being offered by the business, an update to presence information associated with the business (e.g., that business has become busier, that a wait time for a customer representative has been reduced, etc.), an update to stock information associated with the business, and/or another type of update generated by business device 130. As another example, an update relating to private and/or personalized information may be received. For example, an update to an order placed by the user may be received from business device 130.

Other examples of updates that may be received by address book application 450 may include a school closure update for an address book entry corresponding to a particular school; a flight status update for an address book entry corresponding to an airline or an airport; a sports score update for an address book entry corresponding to a sports team or a sports stadium; an indication of how crowded a mall is for an address book entry corresponding to a shopping mall; and/or a cross-selling promotion being offered by a second business for an address book entry corresponding to a first business, wherein the second business is related to the first business or wherein the second business has a cross-selling agreement with the first business.

Users that included the business in their address books may be identified (block 650) and the update may be sent to user devices associated with the identified users (block 660). For example, address book manager 430 may be informed by business device interface 410 that an update has been received by a business and stored in business database 415. Address book manager 430 may identify all users associated with the business in user address book database 435 and may send the update from business database 415 to user devices 110 associated with the identified users.

FIG. 7 is a flowchart of an exemplary process for adding a business to a users' address book according to an implementation described herein. In one implementation, the process of FIG. 7 may be performed by user device 110. In other implementations, some or all of the process of FIG. 7 may be performed by another device or a group of devices separate from user device 110 and/or including user device 110.

The process of FIG. 7 may include receiving a request to add a business to the user's address book (block 710). A user may add a business to the address book using a variety of different techniques. As an example, a user may browse a listing of registered business by accessing a web site associated with address book system 140 and may select to add one of the listed businesses to the user's address book. As another example, address book application 450 may provide a selection object (e.g., a button) to a browser application associated with user device 110 and the selection object may enable the user to add a business, associated with a website the user has accessed, to the address book. Additionally or alternatively, a user may view a listing of businesses on a web site, such as a listing provided by business listings system 150, may highlight a listed business, and may click on the selection object to add the highlighted business to the address book. As yet another example, a user may enter a place of business and user device 110 may identify the business associated with the place of business and may provide the user with an option to add the business to the user's address book. User device 110 may identify a business, associated with a place of business, by determining the location of user device 110 and matching the determined location with a location associated with a particular business. Additionally or alternatively, a device locating within the place of business may emit a signal (e.g., via a WiFi connection, via a Bluetooth connection, etc.) that may be used by user device 110 to identify the particular business, a user may scan a code (e.g., a Quick Response Code, a barcode, etc.) displayed at the place of business to identify the business, and/or may use a different technique to identify the business.

Address book fields may be auto-filled based on information associated with the business (block 720). In response to identifying a business that the user has selected to add to the address book, address book application 450 may request information relating to the business from address book system 140. Address book system 140 may obtain information relating to the identified business from business database 415, may provide the obtained information to user device 110, and may associate the identified business with the user in user address book database 435. Address book application 450 may receive the information and may generate a business record 500 for the identified business. Address book application 450 may auto-fill one or more fields in business record 500 based on the information obtained from address book system 140.

The address book may be configured to receive updates from the business (block 730). For example, address book application 450 may inform address book system 140 that updates from the business should be sent to user device 110. Furthermore, address book application 450 may obtain authentication information from the user for receiving private and/or personalized information relating to the user's account from business device 130 and may inform business device 130 that updates to personalized/private information for the user should be sent to user device 110.

Notifications associated with the business may be configured (block 740). For example, address book application 450 may prompt the user to select when notifications relating to the business should be generated. In some implementations, the user may be prompted to assign an importance rating to the business and the importance rating may be used to determine whether a notification should be generated. In other implementations, the user may be prompted to select types of updates that should generate a notification. For example, the user may select to be notified when a promotion update is received, when a presence information update is received, when a user account update is received (e.g., an update about an order placed by the user), etc. In some implementations, address book application 450 may assign a higher importance score to a business with which a user frequently interacts (e.g., based on visits to a web site associated with the business).

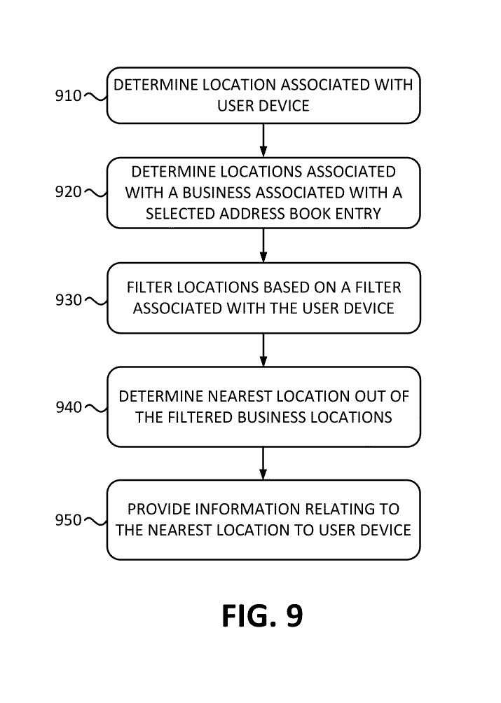

FIG. 8 is a flowchart of an exemplary process for obtaining information relating to a business for an address book according to an implementation described herein. In one implementation, the process of FIG. 8 may be performed by user device 110. In other implementations, some or all of the process of FIG. 8 may be performed by another device or a group of devices separate from user device 110 and/or including user device 110.

The process of FIG. 8 may include detecting a selection of a business in an address book (block 810). For example, the user may activate address book application 450 and address book application 450 may provide to the user a list of business that the user has added to the address book. The user may select a business from the list of businesses in the address book. In response, address book application 450 may display information stored in business record 500 associated with the selected business.

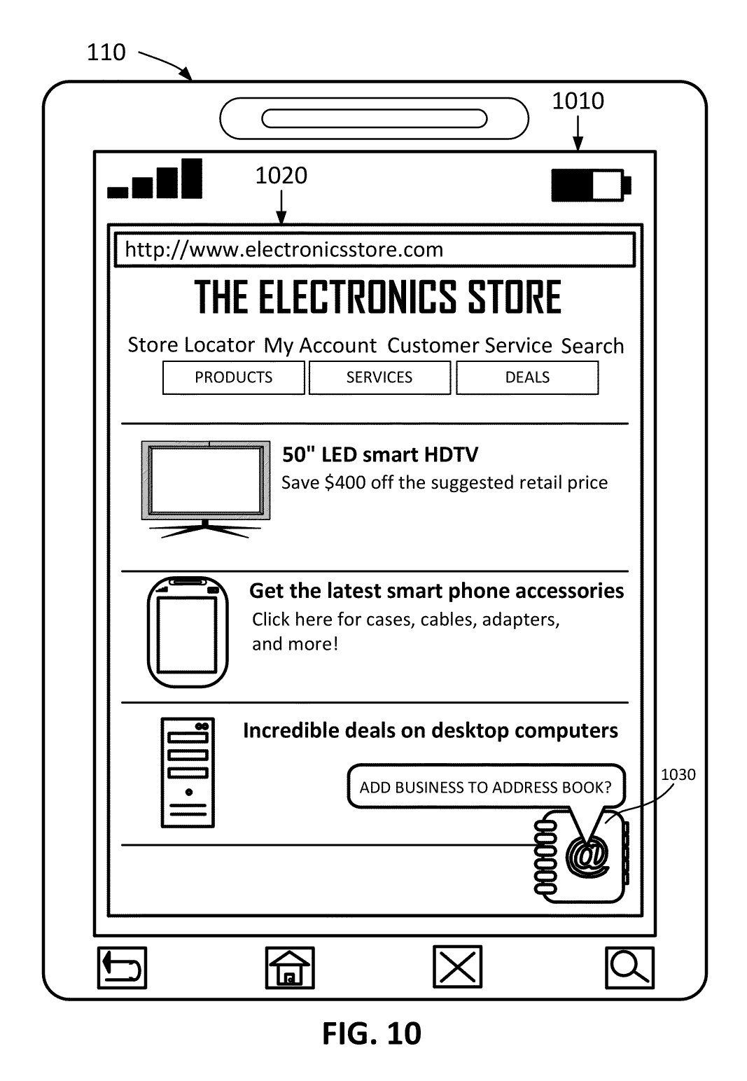

Information relating to the selected business may be requested from an address book system (block 820) and information relating to the selected business may be obtained from the address book system (block 830). For example, address book application 450 may request updated information relating to the selected business from address book system 140. The request may include information identifying the user and/or location information associated with user device 110. Address book system 140 may obtain information relating to the business from business database 415 and provide the obtained information to user device 110. The information may include information identifying a nearest location associated with the business, as described below with reference to FIG. 9.

Personal information relating to the user may be requested from a business device (block 840) and the requested personal information relating to the user may be obtained from the business device (block 850). For example, address book application 450 may request information relating to the user's account, such as information about an order placed by the user and/or other information relating to the user's account, from business device 130. For example, address book application 450 may log into the user's account in business device 130 by using information stored in user account information field 536 and may determine whether any new information is available in relation to the user's account.

The obtained information may be provided in connection with an address book entry of the selected business (block 860). For example, when the user firsts selects an address book entry associated with the business, some information may be displayed immediately and other information may be displayed after information is received from address book system 140. For example, contact information associated with the business may be displayed immediately from address book memory 490, while presence information associated with the business and/or a nearest location associated with the business may be displayed after the information is received from address book system 140.

Address book application 450 may generate a user interface that includes the name of the business, an image area that may include an image associated with the business, an address area that may include a nearest location associated with the business, a presence information area that may include presence information associated with the business, a contact area that may include contact information associated with the business, a hyperlink to a web site associated with the business, a tagline area that may include a tagline associated with the business, a promotion area that may include promotions associated with the business, a user account area that may include private and/or personalized information related to the business or products and services offered by the business, and/or other areas that may include other information associated with the business.

FIG. 9 is a flowchart of an exemplary process for determining a nearest business location according to an implementation described herein. In one implementation, the process of FIG. 9 may be performed by address book system 140. In other implementations, some or all of the process of FIG. 9 may be performed by another device or a group of devices separate from address book system 140 and/or including address book system 140.

The process of FIG. 9 may include determining a location associated with a user device (block 910). For example, user device 110 may determine a location associated with user device 110 using a Global Positioning System (GPS) receiver included in user device 110 and address book application 450 may provide information identifying the location to address book system 140. Locations associated with a business, associated with a selected address book entry, may be determined (block 920). For example, address book system 140 may identify locations, associated with a selected address book entry, that are within a particular distance (e.g., 10 miles, five miles, etc.) of the determined location of user device 110. As an example, if the selected business corresponds to a national chain business, address book system 140 may identify locations that are within a particular distance of user device 110. As another example, if the selected address book entry corresponds to the business category of gas stations, address book system 140 may identify all gas stations within a particular distance of user device 110 (e.g., two miles, one mile, etc.).

The determined locations may be filtered based on a filter associated with the user device (block 930). For example, the user may have selected a filter that may be stored in filter field 516 of business record 500 associated with the selected address book entry. As an example, if the business category corresponds to an emergency medical center, the filter may correspond to identifying an emergency medical center affiliated with a medical insurance associated with the user. As another example, if the business category corresponds to a gas station, the filter may correspond to a particular brand of gas station selected by the user and stored in filter field 516. The nearest location may be determined relative to the current location of user device 110 or relative to a location specified by the user.

A nearest location out of the filtered business locations may be determined (block 940) and information relating to the nearest location may be provided to the user device (block 950). For example, address book system 140 may select the location, out of the filtered locations, that is nearest to the location of user device 110. If no filter is associated with the selected address book entry, address book system 140 may simply select the nearest location of the determined locations. Information relating to the determined nearest location, such as an address and a phone number associated with the determined nearest location, may be provided to user device 110.

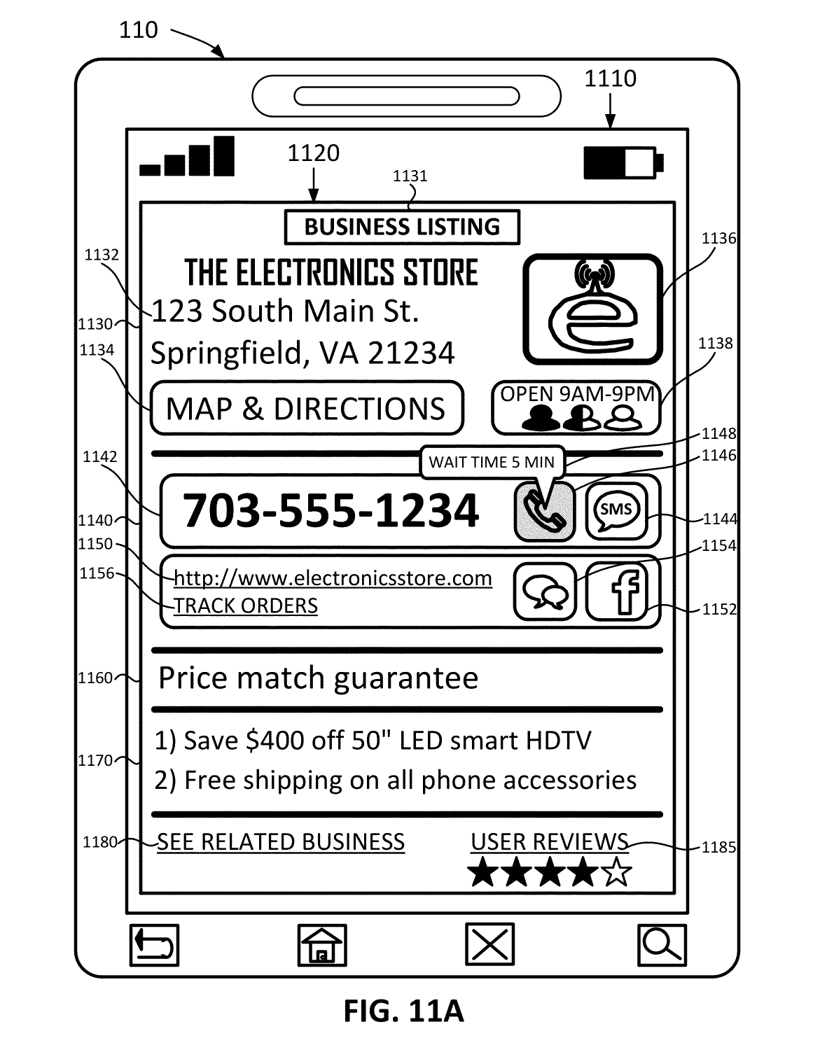

FIG. 10 is a diagram of a first exemplary user interface 1010, generated by user device 110, according to an implementation described herein. As shown in FIG. 10, user interface 1010 may include a browser window 1020 that may be generated by a browser application. Browser window 1020 may display a web site, associated with a business, which may have been accessed by the user of user device 110. Browser window 1020 may include an address book icon 1030. Address book icon 1030 may be provided to the browser application by address book application 450. The user may click on address book icon 1030 to add the business associated with the accessed web site to the address book.

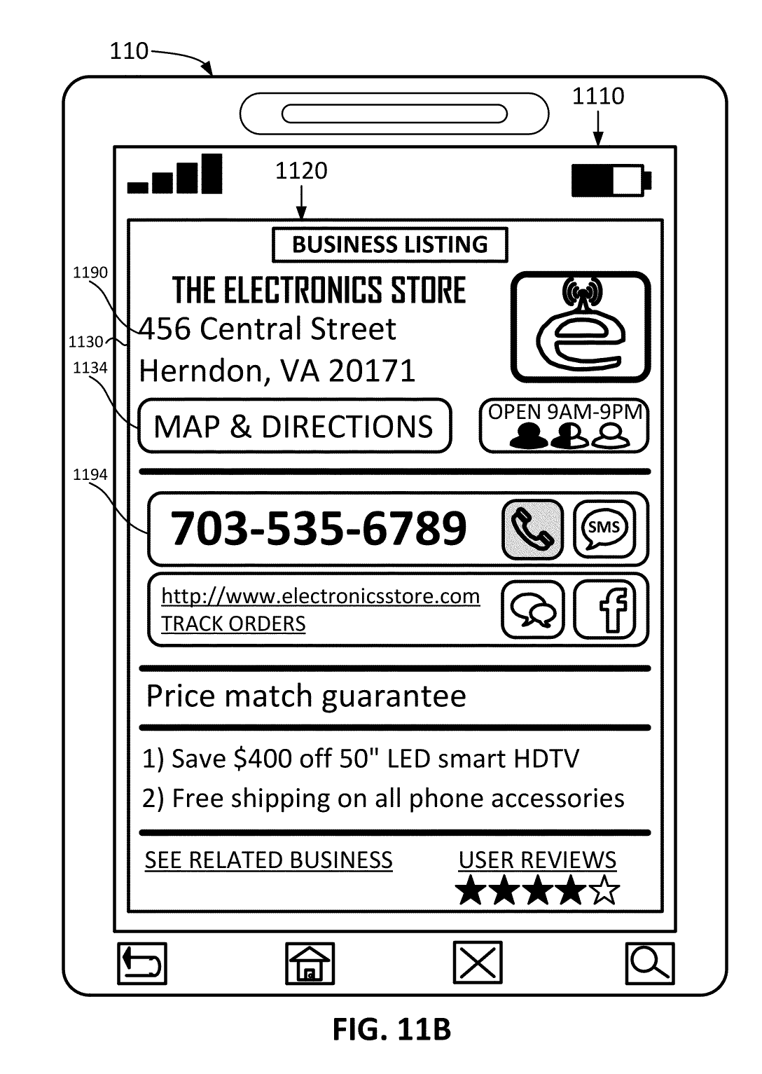

FIGS. 11A-11B are diagrams of a second exemplary user interface 1110, which may display an address book entry 1120 selected by the user, according to an implementation described herein. As shown in FIG. 11A, address book entry 1120 may include a location area 1130, a contact area 1140, a tagline area 1160, a promotion area 1170, a related business link 1180, and a user ratings indicator 1185.

Location area 1130 may include information relating to a nearest location associated with the business associated with address book entry 1120. Location area 1130 may include a listing type indicator 1131, an address 1132, a map and directions button 1134, an image 1136, and a presence indicator 1138. Listing type indicator 1131 may indicate that the address book entry is associated with a business. Address 1132 may include a nearest address associated with the business. Map and directions button 1134 may activate a mapping application, when selected, and may cause the mapping application to display a map that includes the location of user device 110 and the location associated with the business and/or that includes directions from the user's location to the location associated with the business. Image 1136 may include an image associated with the business, such as the logo of the business. Additionally or alternatively, image 1136 may be associated with a selection object that may activate an application associated with the business.

Presence indicator 1138 may include presence information associated with the business. For example, presence indicator 1138 may include the hours associated with the location of the business identified in address area 1130. Furthermore, presence indicator 1138 may indicate whether the business is open. For example, if the business is open, presence indicator 1138 may be in a first color, and if the business is closed, presence indicator 1138 may be in a second color. Moreover, presence indicator 1138 may include an indication of how busy the location of the business identified in address area 1130 is, such as showing a relative indicator of how crowded the location is, as illustrated in FIG. 11A.

Contact area 1140 may include a phone number area 1142 that may display a phone number associated with the business. Phone number area 1142 may include a phone button 1146, which may be used to initiate a phone call to the phone number, and a text messaging button 1148, which may be used to send a text message to the phone number. Furthermore, by touching phone button 1148, tooltip 1148 may be displayed, which may display a wait time to talk to a customer representative.

Contact area 1140 may further include a link 1150 to a web site associated with the business, an instant messaging button 1154 to initiate a chat via the web site associated with the business, a social media button 1152 to access a social media account associated with the business, and a track orders link 1156 to link to an account associated with the user which may include tracking information associated with orders placed by the user through the web site.

Tagline area 1160 may include a tagline associated with the business. Promotion area 1170 may include promotions currently being offered by the business, such as items or sale or discounts offered for particular services. Related business link 1180 may include a link to businesses that are related to the business. User ratings indicator 1185 may display a rating of the business based on reviews submitted by other users.

FIG. 11B may include address book entry 1120 if the user were to select the address book entry at a different location. Address area 1130 of address book entry 1120 may display a different address 1190 that may correspond to the nearest location based on the location of user device 110. Furthermore, map and directions button 1134 may be modified to send the updated address information to the mapping application if the user clicks on the map and directions button 1134. Moreover, a different phone number 1194 may be displayed as well.

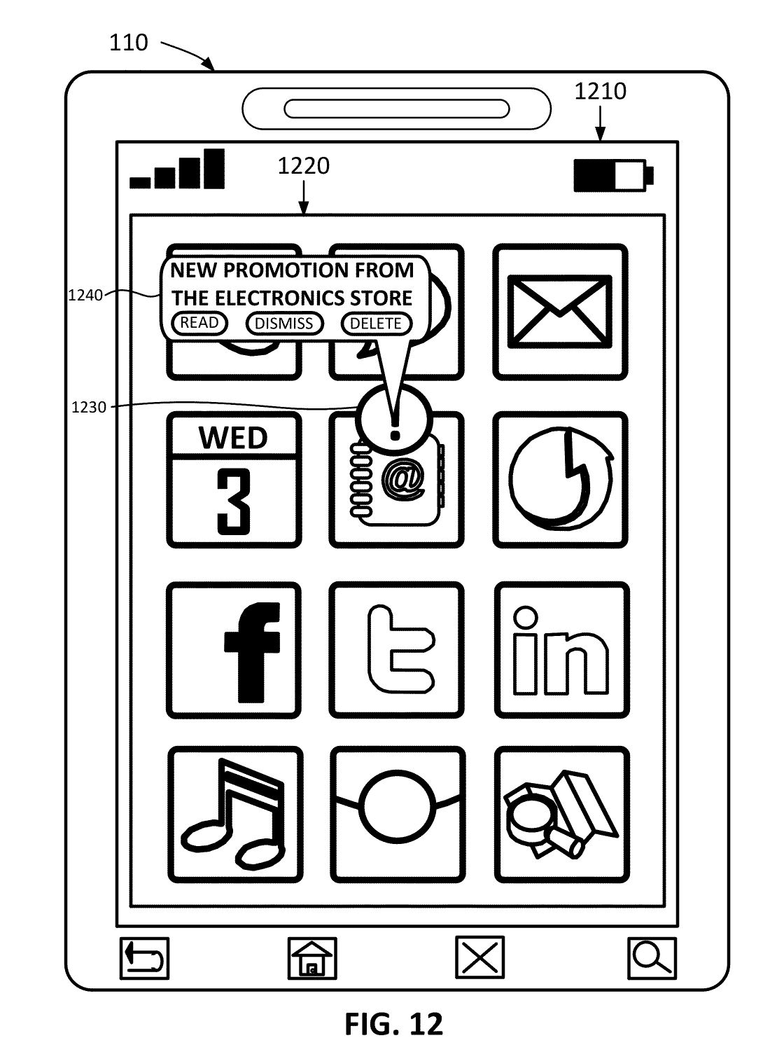

FIG. 12 is a diagram of a third exemplary user interface 1210 according to an implementation described herein. User interface 1210 may include a main window 1220 of user device 110 that may display different applications and/or services that may be activated by the user. Main window 1120 may include an address book icon 1230. The user may activate address book application 450 by selecting address book icon 1230. Furthermore, when an update has been received by address book application 450 from a business and address book application 450 determines that a notification should be generated based on the update, a notification 1240 may be generated and displayed by main window 1220. For example, the notification may inform the user that a new promotion has been made available by a business. The generation of the notification may include an audible tone to alert the user. The user may be provided with an option to read the update, to dismiss the notification, or to delete the update.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

For example, while series of blocks have been described with respect to FIGS. 6-9, the order of the blocks may be modified in other implementations. Further, non-dependent blocks may be performed in parallel.

It will be apparent that systems and/or methods, as described above, may be implemented in many different forms of software, firmware, and hardware in the implementations illustrated in the figures. The actual software code or specialized control hardware used to implement these systems and methods is not limiting of the embodiments. Thus, the operation and behavior of the systems and methods were described without reference to the specific software code—it being understood that software and control hardware can be designed to implement the systems and methods based on the description herein.

Further, certain portions, described above, may be implemented as a component that performs one or more functions. A component, as used herein, may include hardware, such as a processor, an ASIC, or a FPGA, or a combination of hardware and software (e.g., a processor executing software).

It should be emphasized that the terms “comprises”/“comprising” when used in this specification are taken to specify the presence of stated features, integers, steps or components but does not preclude the presence or addition of one or more other features, integers, steps, components or groups thereof.

No element, act, or instruction used in the present application should be construed as critical or essential to the embodiments unless explicitly described as such. Also, as used herein, the article “a” is intended to include one or more items. Further, the phrase “based on” is intended to mean “based, at least in part, on” unless explicitly stated otherwise.

What is claimed is:

1. A method, performed by a computer device, the method comprising:
receiving, by the computer device, an indication from a user device that a user, associated with the user device, has added a business to an address book associated with the user device;
including, by the computer device, the business in the address book associated with the user device;
receiving, by the computer device, an update from a business device associated with the business;
identifying, by the computer device, that the business is included in the address book associated with the user device; and
sending, by the computer device, the update to the user device in response to receiving the update and based on identifying that the business is included in the address book associated with the user device.

2. The method of claim 1, wherein the update includes:
a promotion being offered by the business;
presence information associated with the business;
information associated with an order placed by the user with the business;
a hyperlink associated with the business; or
stock information associated with the business.

3. The method of claim 2, wherein the presence information associated with the business includes:
information relating to whether the business is open for business;
business hours associated with the business;
information relating to how busy the business is; or
a wait time for speaking with a customer representative of the business.

4. The method of claim 1, further comprising:
receiving information relating to the business from the business device; and
storing the receiving information in a business database associated with the computer device.

5. The method of claim 4, further comprising:
receiving, from the user device, a request for information relating to the business; and
providing at least some of the stored information, relating to the business, to the user device from the business database, in response to receiving the request.

6. The method of claim 5, wherein providing at least some of the stored information, relating to the business, to the user device from the business database includes:
determining a location associated with the user device;
determining a location associated with the business nearest a location associated with the user device; and
providing information relating to the determined nearest location to the user device.

7. The method of claim 5, wherein the received information includes:
presence information associated with the business;
a promotion associated with the business;
information associated with an order placed by the user with the business;
a hyperlink associated with the business;
stock information associated with the business; or
information associated with an account of the user with the business.

8. The method of claim 5, wherein providing at least some of the stored information, relating to the business, to the user device from the business database includes:
determining a location associated with the user device;
determining a plurality of locations associated with the business, wherein the plurality of locations are within a particular distance of the location associated with the user device;
determining a filter associated with the user for the business;
filtering the plurality of locations based on the determined filter;
determining a nearest location associated with the business from the filtered plurality of locations based on the determined location associated with the user device; and
providing information relating to the determined nearest location to the user device.

9. A method performed by a mobile communication device, the method comprising:
receiving, by the mobile communication device, a request from a user to add a business to an address book;
obtaining, by the mobile communication device, information relating to the business from an address book system in response to receiving the request from the user to add the business to the address book;
auto-filling, by the mobile communication device, one or more fields in the address book to create an address book entry for the business, based on the obtained information;
receiving, by the mobile communication device, an update associated with the business from the address book system; and
updating, by the mobile communication device, the address book entry for the business based on the received update.

10. The method of claim 9, wherein receiving the request from a user to add a business to an address book includes:
detecting a selection of an address book selection object;
determining that the user device is accessing a web site while the selection is detected;
identifying the business as being associated with the web site; and
generating the request to add the business to the address book based on identifying the business.

11. The method of claim 9, wherein receiving the request from a user to add a business to an address book includes:
detecting a selection of an address book selection object;
determining that the user device is located within a business location while the selection is detected;
identifying the business as being associated with the business location; and
generating the request to add the business to the address book based on identifying the business.

12. The method of claim 9, wherein auto-filling the one or more fields in the address book to create an address book entry for the business includes:
auto-filling a location field based on location information associated with the business;
auto-filling a presence information field based on presence information associated with the business;
auto-filling a contact information field based on contact information associated with the business;
auto-filling a hyperlink field based on a hyperlink associated with the business;
auto-filling a promotion information field based on promotion information associated with the business;
auto-filling a tagline field based on a tagline associated with the business;
auto-filling a stock information field based on stock information associated with the business; or
auto-filling a review field based on reviews associated with the business.

13. The method of claim 9, wherein the update includes:
a promotion being offered by the business;
presence information associated with the business;
information associated with an order placed by the user with the business;
a hyperlink associated with the business; or
stock information associated with the business.

14. The method of claim 9, further comprising:
detecting that the user has selected the address book entry for the business; and
obtaining updated information relating to the business from the address book system, in response to detecting that the user has selected the address book entry for the business.

15. The method of claim 9, further comprising:
detecting that the user has selected the address book for the business;
generating a user interface that includes two or more of:
an address area that includes an address associated with the business;
a presence information area that includes presence information associated with the business;
a contact information area that includes contact information associated with the business;
a tagline area that includes a tagline associated with the business;
a promotion area that includes one or more promotions associated with the business; or
a selection object to activate an application associated with the business.

16. A computer device comprising:
logic configured to:
receive an indication from a user device that a user, associated with the user device, has added a business to an address book associated with the user device;
include the business in the address book associated with the user device;
receive an update from a business device associated with the business;
identify that the business is included in the address book associated with the user device; and
send the update to the user device in response to receiving the update and based on identifying that the business is included in the address book associated with the user device.

17. The computer device of claim 16, wherein the update includes:
a promotion being offered by the business;
presence information associated with the business;
information associated with an order placed by the user with the business;
a hyperlink associated with the business; or
stock information associated with the business.

18. The computer device of claim 17, wherein the presence information associated with the business includes:
information relating to whether the business is open for business;
business hours associated with the business;
information relating to how busy the business is; or
a wait time for speaking with a customer representative of the business.

19. The computer device of claim 16, wherein the logic is further configured to:
receive information relating to the business from the business device;
store the receiving information in a business database associated with the computer device;
receive, from the user device, a request for information relating to the business; and
provide at least some of the stored information, relating to the business, to the user device from the business database, in response to receiving the request.

20. The computer device of claim 19, wherein, when the logic is configured to provide at least some of the stored information to the user device, the logic is further configured to:
determine a location associated with the user device;
determine a plurality of locations associated with the business, wherein the plurality of locations are within a particular distance of the location associated with the user device;
determine a filter associated with the user for the business;
filter the plurality of locations based on the determined filter;
determine a nearest location associated with the business from the filtered plurality of locations based on the determined location associated with the user device; and
provide information relating to the determined nearest location to the user device.
